(19) United States
(12) Patent Application Publication
(10) Pub. No.: US 2009/0025956 A1
(43) Pub. Date: Jan. 29, 2009

(54) Security or Safety Bus System

(76) Inventor: Timothy Christopher Stubbs, Birmingham (GB)

Correspondence Address: Mr. Thomas M. Wozny;Andrus, Sceales, Starke & Sawall, LLP, Suite 1100, 100 East Wisconsin Avenue, Milwaukee, WI, 53202-4178, US

(21) Appl. No.: 12/141,631

(22) Filed: Jun. 18, 2008

Related U.S. Application Data
(63) Continuation of application No. 10/854,861, filed on May 27, 2004, now abandoned.

(30) Foreign Application Priority Data
May 30, 2003 (GB) 03 12414.6

(51) Int. Cl. H02G 5/00

(52) U.S. Cl. 174/68.2

(57) ABSTRACT

A bus system for an industrial guard has a support on which is supported a plurality of modules each having at its two ends respectively first and second parts of a multi-way connector, whereby one module may be electrically connected to another module already mounted on the support. Each module has a pair of safety conductors extending between the connector parts and in a safety circuit and a further pair of data conductors also extending between the connector parts and in a data circuit. A given module may include a switch to break the circuit including the safety conductors, or a component which feeds data to the data conductor or which is controlled by data carried by the data conductor.

### CROSS REFERENCE TO RELATED APPLICATIONS

This application claims the priority of UK Patent Application No. 0312414.6 filed on 30 May 2003.

### BACKGROUND OF THE INVENTION

a) Field of the Invention

This invention relates to a modular bus system for a security environment, as well as to a method for implementing such a modular bus system. In particular, though not exclusively, this invention relates to a modular bus system for an industrial guard arrangement, used for example to protect industrial machinery or a process.

Though the invention could be applicable to other security environments, in the following it will be described expressly in relation to an industrial guard arrangement, adapted and configured to restrict access to industrial machinery whenever that machinery is in operation or is in an active state. It is to be understood that the invention is not limited to this particular use.

b) Description of the Related Art

In an industrial environment, personnel must be protected from active or operating machinery and for this purpose it is known to provide a security guard system which is interconnected with a control system for the machinery. With increasingly complex industrial processes, such security guard systems have also become more complex, requiring large quantities of wiring running around the guard system in order to feed signals back to a controller indicative of the state of doors, access hatches, lock mechanisms for such doors or hatches, control switches and so on. The more complex the assemblies and the wiring, the greater the risk of a failure in the security system, which could endanger personnel in the vicinity of the machinery.

In an attempt to reduce the complexity of the wiring associated with conventional guard systems, various standardised bus systems have been developed, where information is fed to a microprocessor-based controller along a multi-wire bus, using standardised signals to indicate the state of various components controlled by or to control the guards and the machinery associated therewith. Despite this, there are still difficulties in connecting the various switches, sensors, mechanisms and so on to the standardised bus system, requiring skilled wiring and also the possibility of failure on account of the complexity and vulnerability of that wiring.

It is a principal aim of the present invention to provide a modular bus system which is suitable for use in connection with the various components of an industrial guard system (or a generally similar security environment requiring protection), to facilitate the interconnection of the components to be controlled by or which are to feed information to a centralised controller, using a chosen standardised bus system to communicate between the modular bus system of this invention and the controller. Further, it is an aim of this invention to provide a method for furnishing such a modular bus system.

### BRIEF SUMMARY OF THE INVENTION

According to one aspect of this invention, there is provided a modular bus system for a security environment in which electrical signals are transferred between a controller and individual components. The bus system has a plurality of modules for selective interconnection, each module having at one end a first part of a multi-way connector and at the other end a second part of the multi-way connector of a complementary form to the first part whereby a module may be engaged with another to interconnect the adjacent connector parts. Each module defines at least one pair of safety conductors forming a part of a safety circuit and which directly link between the connector parts of the module, and each module further defines at least two further conductors forming a part of a data circuit and which further conductors also directly link between the connector parts of the module and respectively carry power and data. At least some of the modules have a component which is connected to the data conductor and is arranged to cooperate therewith, by at least one of feeding data to the data conductor and receiving data from the data conductor so as to be controlled thereby.

According to a second but closely related aspect, this invention provides a method of implementing a modular bus system for a security environment in which electrical signals are transferred between a controller and individual components. A support is provided at the required site within the security environment, and a plurality of modules are mounted on the support, each module having at one end a first part of a multi-way connector and at the other end a second part of the multi-way connector of a complementary form to the first part whereby engaging a module with a module which has already been mounted on the support electrically connects the respective adjacent connector parts of the two modules. A safety circuit is provided by at least one pair of safety conductors which directly link between the connector parts of the module. Further, a data circuit is provided by at least two further conductors and which also directly link between the connector parts of the module and respectively carry power and data. At least some of the modules engaged with the support include a component which feeds data on to or is controlled by data on the data circuit.

The bus system of this invention allows the collocation together of a plurality of individual modules each of which has a function associated with an industrial guard system (or possibly some other security environment), either to be controlled by data supplied by a centralised controller, or to feed data back to that controller. Further, the bus system permits the provision of at least one, but preferably two or possibly even more, safety circuits having a high degree of integrity and reliability, all without the need for individual wiring which otherwise would have to be implemented at the time of installation of the guard arrangement for the machinery or industrial process to be protected. As such, the bus system of this invention may give greater reliability and so security in operation, as well as facilitating the implementation of the guard system.

### BRIEF DESCRIPTION OF THE DRAWINGS

One specific embodiment of this invention will now be described in detail, though only by way of example, reference being made to the accompanying drawings. In the drawings:

FIG. 1 illustrates a plurality of modules implementing the embodiment of bus system of this invention, which modules are shown mounted on a common rail;

FIG. 2 shows a simple arrangement of two interconnected modules;

FIG. 3 is a partially cut away view of the assembly of FIG. 2;

FIG. 4 illustrates the interconnection of two modules, including the connector parts of those modules;

FIGS. 5 and 6 show two further more complex assemblies of modules; and

FIG. 7 diagrammatically shows the electrical interconnection of several modules.

### DETAILED DESCRIPTION OF THE INVENTION

Each module of the bus system may have a third conductor associated with the data circuit of the module, which third conductor also directly links between the connector parts of the module. That third conductor conveniently serves as a common return for the bus system. Of course, further conductors may also be provided within each module and linking between the connector parts of the module, as may be required.

A second safety circuit may be implemented within the bus system by providing within each module a second pair of safety conductors linking between the connector parts of the module. The or each pair of safety conductors should be arranged such that if the circuit including those conductors is broken, then the system immediately should effect a shut-down of whatever machinery or process is being controlled. The safety circuit advantageously by-passes the main centralised controller, to ensure ultimate reliability in the event that there is a failure of any kind. This may be achieved by detecting whether the circuit including those conductors is broken, in any way or at any place. Further, at least one of the modules to be included in the system may be configured to have a switch arrangement connected in series with at least one of the safety conductors of that module and which switch is opened upon detection of a serious fault condition. In addition or alternatively, the module may include an external emergency stop button, the depression of which serves to open the switch and so signal to the controller that an immediate shut-down is required.

Various modules may be incorporated in the bus system, to suit the environment to be protected. For example, there may be a switch module having a switch which is operable by a mechanism externally of the module and which feeds data on to the data conductor indicative of the state of the switch. Such a switch could be operated by the closing or the opening of a door or guard. Alternatively, the switch could be key-operated whereby only those in possession of the appropriate key might operate the switch, for instance when the machinery is to be switched on or off. Other modules may include warning lights, push buttons, a proximity sensor and so on.

Further modules may be active, in the sense that they include a mechanism which is actuated by data placed on the data circuit by the centralised controller. For example, a module may have a motor, solenoid or other actuator arranged to effect movement of a component linked into the module. Such a module could be used to effect the locking of a door in a closed position though it may have many other uses, as well.

There may also be provided a termination module which includes an interface circuit which converts the signals of the data circuit of the modules to the external standardised bus. Such a termination module should include a connector for the standardised bus whereby a single multi-conductor cable may easily be connected to the termination module, to feed signals to and from the centralised controller. Further, the termination module may allow for the connection of the safety circuits within the modules to external safety wiring.

There may be provided a support for the modules, to facilitate the interconnection of the modules. Such a support may be in the form of a rail along which the modules are slidable. Advantageously, each module includes a housing adapted for interengagement with the mounting rail. In a preferred embodiment, the rail includes a groove and each module has a peg engageable in that groove whereby a selected module may be slid along the mounting rail to the required position and be connected to an already-mounted module. The connector parts of each module may then be provided at the two ends respectively of the module, which connector parts are mounted on a printed circuit board furnished within the module, to provide the conductors extending between the two connector parts.

Preferred embodiments of the invention will now be described in detail, referring to the drawings as appropriate.

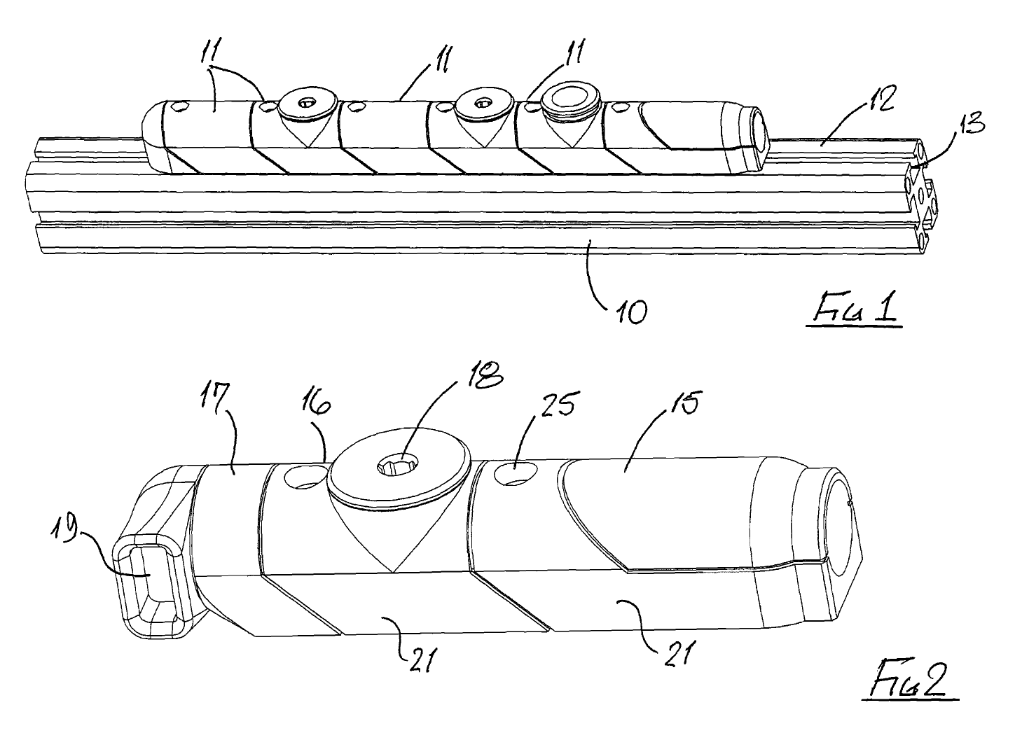

In FIG. 1, there is shown a rail 10, for example of extruded aluminium alloy, which slidingly supports a plurality of interconnected modules 11, together implementing the bus system of this invention, for use in connection with an industrial guard arrangement (not shown). The rail includes a mounting surface 12 below which there is a re-entrant channel 13, each of the modules having a downwardly-projecting foot (not shown) including a head which is slidingly received within that channel 13. The head is connected to the housing of the module by a stem which passes through the mouth of the channel so that each module may be engaged with the rail 10 from an end thereof, and then may be slid along the surface 12 so as to engage another module already provided on that rail. As shown in the drawings, modules are mounted on only one mounting surface 12 of the rail 10, though for complex installations it would be possible to provide modules on more than one of the mounting surfaces.

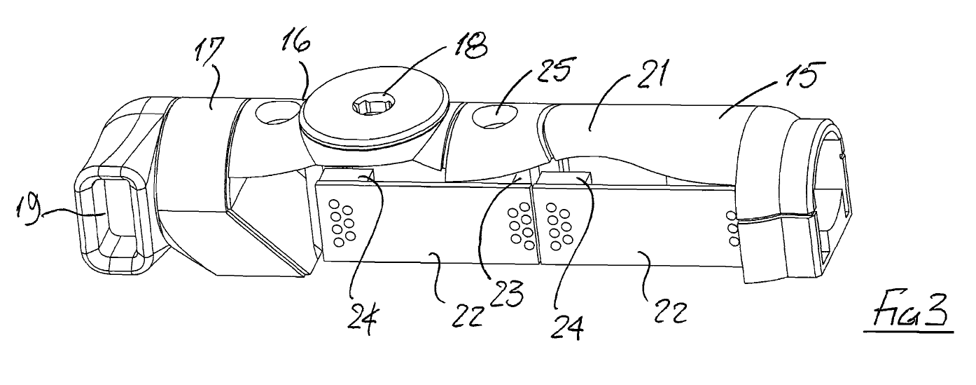

The configuration of the modules will now be described in more detail, referring to FIGS. 2 to 6. In FIG. 2, there is shown an assembly of two modules, these comprising a connection module 15 and a mechanical lock module 16 which includes a rotary head mechanism 17. The mechanical lock module 16 has a socket 18 for a key (not shown) the socket being coded such that only a correspondingly-coded key may be engaged therewith. The socket 18 may be replaced by a conventional cylinder lock mechanism, operable only by a suitable key. In either case, once the key has been engaged, the state of a mechanism within the mechanical lock module, and also the state of a switch associated with that mechanism, may be changed. The switch is connected to a data bus passing through the module, as will be described below, such that the operation of the mechanism may be electrically sensed. The head mechanism 17 has a socket 19 for a lever or striker plate (not shown) the socket being mounted for rotation about an axis extending along the length of the modules but being mechanically interlocked with the mechanical lock module whereby such rotary movement is permitted or prevented, depending upon the setting of the mechanism of the mechanical lock module.

In a typical embodiment, the striker plate would be provided on a hinged door and is engageable in the socket 19 in such a way that fully closing the door turns that socket about its axis of rotation. On removing a key from the lock mechanism, the socket is then locked in that position by a runner-bar within the module 16 and the door can be opened only after the key has been re-engaged with the module and turned to reset the mechanism to its original state.

The head mechanism 17 includes electrical terminations for safety circuits provided within the modules, as will be described below, to ensure proper operation of the safety circuit.

The connection module 15 includes an electronic interface for the data bus within the mechanical lock module 16 to permit the connection thereto of a standardised bus system such as that known in the industry as an AS-i bus though other standardised bus systems could be employed, if required. Further, the connection module 15 includes a connector for safety circuits, as will be described below.

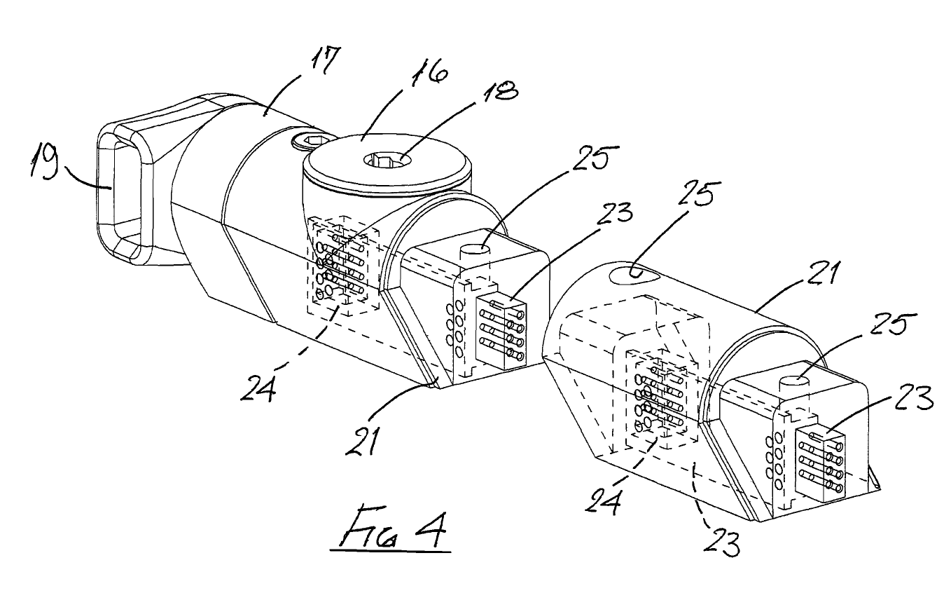

Each module has a housing 21 which is advantageously moulded from a plastics material and is configured to support the required components therewithin, together with a printed circuit board 22 (FIG. 3) and a pair of complementary connector parts 23,24, electrically connected to conductors defined on the printed circuit board 22. The connector parts are shown in more detail in FIG. 4, and it can be seen that at the right-hand end of each module (in FIG. 4) there is provided a female connector part 23 defining seven sockets for individual conductors and at the left-hand end of each module, there is provided a male connector part 24 having seven conductor pins which can be received in the female connector part of the next adjacent module, as the modules are slid together. The printed circuit board 22 provides conductors extending between those connector parts as well as permitting connection to those conductors as may be required by any individual module.

Also shown in FIG. 4 is the configuration of the housing 21, to facilitate the interconnection of the connector parts. Further, at both ends of each housing 21, there is a bore 25 arranged so that the respective bores of two housings will come into register as the two housings are fully engaged. The housings are then held against separation by means of a screw or pin fitted into the aligned bores.

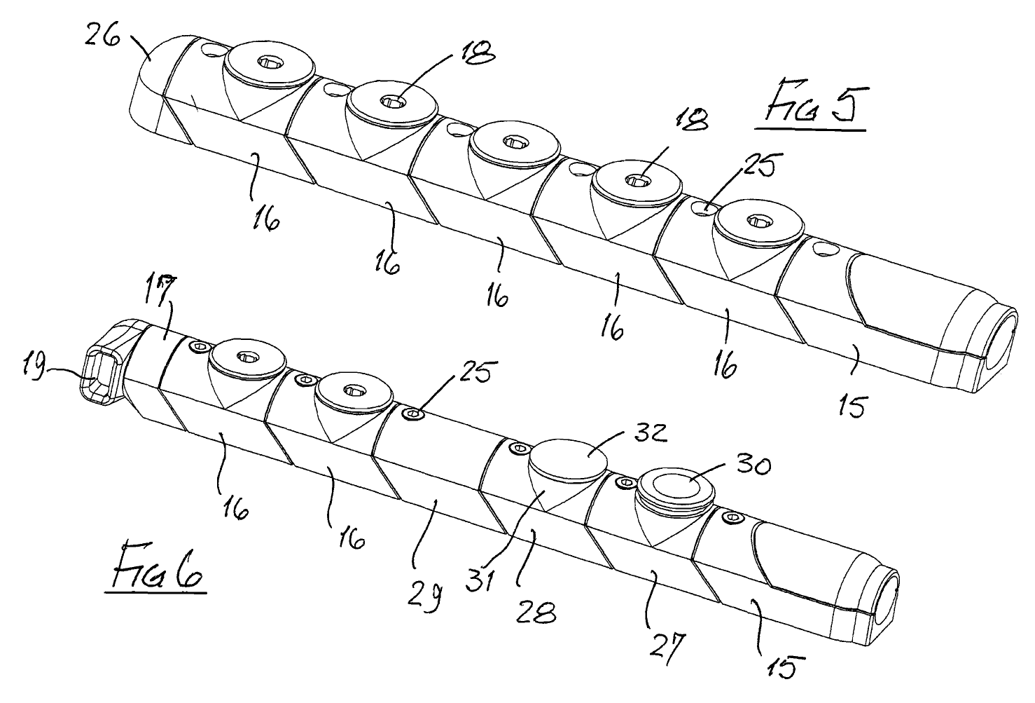

In FIG. 5, there is shown an assembly of five mechanical lock modules 16, a connection module 15 and an end cap 26, which serves to close off access to the male connector part 24 of the end mechanical lock module 16, and also terminates the safety circuits, as will be described below. Internally, the mechanical lock modules are mechanically interlinked by runner-bars such that the respective mechanisms may be operated only in a given sequence (and usually sequentially from one end or the other of the row of modules, depending upon the initial setting), each mechanical lock module also feeding data to the data bus by means of a respective switch incorporated within the module, to indicate the state of each module. The connection module 15 is as has been described above with reference to FIG. 2, to permit the interfacing of the data conductor of the modules to an external bus system.

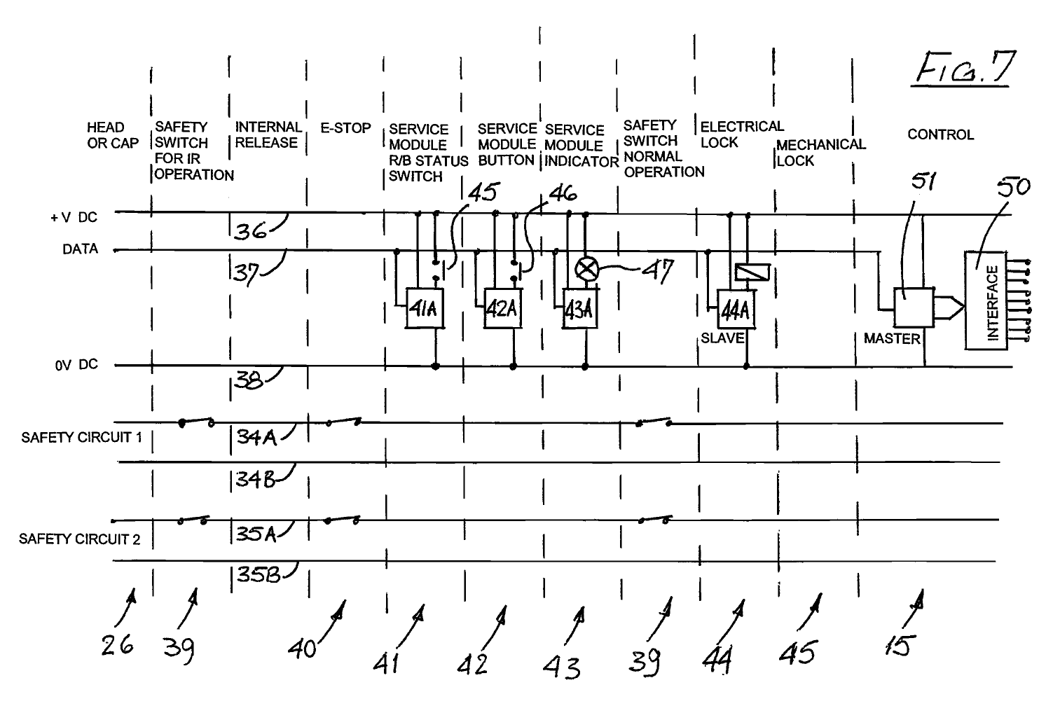

FIG. 6 similarly shows an assembly of modules but here including a connection module 15, a push button module 27, an indicator module 28, a null module 29, two mechanical lock modules 16 and a head mechanism 17, which latter are as has been described with reference to FIG. 2. The push button module 27 includes a manually depressible button 30 connected to a momentary switch provided within the module and which may either be made or broken as required upon depression of the button. The switch may be associated with the data conductor within the module, or could be associated with safety conductors provided therewithin. In the latter case, the switch could be either a simple safety switch for normal operation, or could be an emergency stop switch. Either way, the normal configuration would be for depression of the button to open the safety circuit within the module.

The indicator module 28 includes an upstand 31 having a lens 32 beneath which is mounted an indicator light, the illumination of the light being controlled by data on the data bus passing through the module. The null module 29 is provided merely to separate the indicator module from the mechanical lock modules 16 by a sufficient distance; this null module 29 includes female and male connector parts 23,24 together with a printed circuit board 22 defining conductors linking together the connector parts but otherwise does not participate in the mechanical or electrical arrangements of the bus system.

FIG. 7 shows the electrical system of the embodiment of bus system of this invention, employing ten modules such as those which have been described above, and an end cap 26. The junctions between the modules are shown by broken lines. The seven conductors 34A,34B, 35A,35B, and 36 to 38 are defined on the printed circuit boards 22 of the several modules and are directly interconnected by the interengagement of the modules so as to provide continuous conductors running through the assembly of modules.

The two pairs of conductors 34A,34B and 35A,35B form part of two safety circuits which operate in parallel and though one of the circuits is essentially redundant, safety in operation is enhanced by duplicating the two circuits. If a discrepancy should arise as between the two safety circuits, then a shut-down of the process being controlled or protected by the bus system may immediately be implemented. Within the end cap 26, the conductors 34A,34B and 35A,35B are separately connected together, whereby there is a continuous circuit defined by those pairs of conductors. Normally closed switches provided within safety switch modules 39 are opened on external operation of a safety switch. Similarly, on depression of an emergency stop button of module 40, the switches associated with that module will open the two safety circuits.

Conductor 36 carries a positive DC voltage for operation of the components associated with the modules and conductor 37 carries data which may be organised in any appropriate and well understood manner, which forms no part of this invention and so will not be described here. Conductor 38 is the common return both for the DC voltage and the data conductor.

Modules 41, 42, 43 and 44 are all service modules including respective slave components 41A, 42A, 43A and 44A. Module 41 includes a switch 45 connected to its slave component 41A, whereby the state of that switch 45 is fed to the data conductor 37. Module 42 has a push button switch 46 and its slave component 42A will feed data to the data bus indicating when that switch has been depressed. Module 43 includes an indicator light 47 which will be illuminated when appropriate data is supplied on the data conductor 37, as detected by the slave component 43A. Module 44 includes a solenoid 48 which is energised when appropriate data is supplied on the data conductor 37, as detected by the slave component 44A.

Module 45 could be a null module such as has been described above, or could be a mechanical interconnection module which does not participate electrically in the bus system but is associated mechanically with runner-bars which may extend between the various mechanisms of the guard arrangement.

The connection module 15 includes a programmed interface unit 50 for the external bus with which the bus system is to be associated. By selection of an appropriate interface unit 50, the bus system may readily by connected to different external buses. A master component 51 connects the data conductor 37 to the interface unit 50 and acts as an i/o (input-output) unit for data to be fed to and read from the data conductor.

Other configurations of the modules are possible, as has been described above, but the interconnection of the modules to the interface contained with the connection module 15 is achieved automatically upon sliding the respective modules into engagement with each other. Further the integrity of the two safety circuits is automatically maintained no matter how the configuration of the modules might be changed.

I claim:

1. A bus system for a security environment in which electrical signals are transferred between a controller and individual components, in which bus system there is provided a plurality of modules for selective interconnection, each module having opposed one and other ends, a first part of a multi-way connector provided at one end of each module and a second part of the multi-way connector of a complementary form to the first part provided at the other end whereby a module may be engaged with another module to interconnect the adjacent connector parts thereof, each module defining at least one pair of safety conductors forming a part of a safety circuit said safety conductors directly linking between the connector parts of the module, and each module further defining at least two further conductors forming a part of a data circuit, said further conductors also directly linking between the connector parts of the module and respectively carrying power and data, at least one of the modules including a component connected to the data conductor and arranged to cooperate therewith by at least one of feeding data to the data conductor and receiving data from the data conductor so as to be controlled thereby.

2. A bus system as claimed in claim 1, wherein each module has a third conductor for the data circuit, said third conductor directly linking between the connector parts of the module.

3. A bus system as claimed in claim 2, wherein the third conductor serves as a common return for the bus system.

4. A bus system as claimed in claim 1, wherein each module defines a second pair of safety conductors which form a part of a second safety circuit, which second pair of safety conductors directly link between the connector parts of the module.

5. A bus system as claimed in claim 1, wherein at least one module serves as a safety switch module, a switch arrangement being provided in the module which switch arrangement is in series with one of the safety conductors of said one pair thereof within the safety module.

6. A bus system as claimed in claim 4, wherein one module serves as a safety switch module, said safety switch module being provided with first and second switches, the first switch being associated with the one pair of safety conductors and the second switch with the second pair of safety conductors.

7. A bus system as claimed in claim 5, wherein the switch arrangement in the safety switch module is a normally-closed switch, the switch being opened by a function requiring one of a safety warning and shutdown operation.

8. A bus system as claimed in claim 6, wherein the first and second switches are both normally-closed switches, at least one of the first and second switches being opened by a function requiring one of a safety warning and shutdown operation.

9. A bus system as claimed in claim 1, wherein at least one of the modules incorporates a switch having at least two states, said switch being operable externally of the module and feeding data on to the data conductor indicative of the state of the switch.

10. A bus system as claimed in claim 9, wherein the switch comprises one of a manually-operable switch and a switch operable by a mechanism associated with a security environment in which the bus system is installed.

11. A bus system as claimed in claim 1, wherein at least one of the modules incorporates an indicator which is operable by data on the data conductor to indicate the status of a component associated with the bus system.

12. A bus system as claimed in claim 1, wherein at least one of the modules incorporates an electromagnetic actuator operable by data on the data conductor, said electromagnetic actuator being associated with the locking of a component associated with a security environment in which the bus system is installed.

13. A bus system as claimed in claim 1, wherein the plurality of modules includes an end module configured as a control module, said end module having an interface unit connected to the further conductors and arranged to convert the data on the data conductor to and from a standardised multi-wire bus format for interconnection to a data processor.

14. A bus system as claimed in claim 13 and including a computer unit in communication with the interface unit and running a control program for the security environment.

15. A bus system as claimed in claim 1 and further comprising a support for the modules, each module being slidably mountable on said support.

16. A bus system as claimed in claim 15, wherein said support comprises a rail with which each module is selectively engageable for sliding movement therealong.

17. A bus system as claimed in claim 16, wherein each module is in the form of a housing slidingly interengageable with the rail, whereby a module may be engaged with the rail and slid therealong to engage and then electrically connect its connector part with the corresponding connector part of a module already engaged with the rail.

18. A bus system as claimed in claim 17, wherein the rail has a re-entrant channel formed therealong, and each module housing has a face for sliding engagement with the rail, there being a projecting peg which is receivable in the channel to retain the housing to the rail.

19. A bus system as claimed in claim 18, wherein the projecting peg is in the form of an enlarged head engageable with the channel from one end thereof.

20. A bus system as claimed in claim 1, wherein there is provided holding means to hold together and resist the separation of two modules which have been interengaged, one with the other.

21. A bus system as claimed in claim 20, wherein said holding means comprises a pin which is insertable through aligned openings in the interengaged modules.

22. A bus system as claimed in claim 16, wherein a printed circuit board is provided within the housing of each module, said printed circuit board extending along the length of the housing and carrying at its two ends the complementary connector parts, the printed circuit board defining the conductors extending between the connector parts.

23. A method of providing a bus system for a security environment in which electrical signals are transferred between a controller and individual components, which method comprises:
providing a support at the required site within the security environment;
mounting a plurality of modules on the support, each module having at one end a first part of a multi-way connector and at the other end a second part of the multi-way connector of a complementary form to the first part whereby engaging a module with a module which has already been mounted on the support electrically connects the respective adjacent connector parts of the two modules;
providing a safety circuit including one pair of safety conductors, each module having a pair of conductors which directly link between the connector parts of the module to form a part of the safety circuit;
providing a data circuit including at least two further conductors, each module having at least two further conductors which also directly link between the connector parts of the module and respectively carry power and data, at least some of the modules engaged with the support having a component which feeds data on to or is controlled by data on the data circuit.
